(19) United States
(12) Patent Application Publication
(10) Pub. No.: US 2012/0080599 A1
(43) Pub. Date: Apr. 5, 2012

(54) APPARATUS AND METHOD FOR NEUTRON DETECTION BY CAPTURE-GAMMA CALORIMETRY

(76) Inventors: Guntram Pausch, Dresden (DE); Claus Michael Herbach, Haan (DE); Jürgen Stein, Wuppertal (DE)

(21) Appl. No.: 13/376,613

(22) PCT Filed: Jul. 27, 2009
(86) PCT No.: PCT/EP2009/059691

§ 371 Date: Dec. 7, 2011

(51) Int. Cl. G01T 3/06

(52) U.S. Cl. 250/362; 250/367

(57) ABSTRACT

An apparatus for detecting neutron radiation includes a first section with a high neutron absorption capability and a second section with a low neutron absorption capability. The second section includes a gamma ray scintillator having an inorganic material with an attenuation length of less than 10 cm for gamma rays of 5 MeV energy. The material of the first section releases the energy deployed in the first section by neutron capture mainly via gamma radiation. A substantial portion of the first section is covered by the second section. An evaluation device determines the amount of light detected by a light detector for one scintillation event, and the amount is in a known relation to the energy deployed by gamma radiation in the second section. The evaluation device classifies detected radiation as neutrons when the measured total gamma energy Eₛᵤₘ is above 2,614 MeV.

### CROSS-REFERENCE TO RELATED APPLICATION

This application is a National Stage of PCT International Patent Application No. PCT/EP2009/059691, filed Jul. 27, 2009, the disclosure of which is incorporated herein by reference.

### BACKGROUND OF THE INVENTION

1. Field of the Invention

Aspects of the present invention relate to an apparatus for detecting neutron radiation, preferably thermal (slow) neutrons, utilizing a gamma ray scintillator for indirect detection.

2.Description of the Related Art

In spite of a broad variety of methods and devices which are available for neutron detection, the common ³He tube is still dominating in most applications which require neutron counting with highest efficiency at lowest expense. However, a shortage of ³He is expected, so that there is a need for alternatives.

Such alternative detectors are known in the prior art. Knoll, Radiation Detection and Measurement, 3rd edition 2000, page 506, states that all common reactions used to detect neutrons are reactions with charged particle emission. More specifically, the possible reaction products used for detection are the recoil nuclei (mostly protons), tritons, alpha-particles and fission fragments. Nevertheless, gamma rays following a neutron capture reaction are used in some specialized detectors but these applications are relatively rare.

A detector using a gamma ray scintillator has been disclosed in U.S. Pat. No. 7,525,101 B2 of Grodzins. Grodzins discloses a detector, comprising a neutron scintillator, being opaque for incoming optical photons, sandwiched between two light guides, one of the light guides serving as a gamma ray scintillator also. This detector also generally utilizes heavy charged particle emission following a neutron capture. Grodzins does mention ⁶Li, ¹⁰B, ¹¹³Cd, or ¹⁵⁷Gd as neutron capture materials. Those are used in combination with a ZnS scintillation component, wherein the charged particles loose energy, causing the ZnS material to scintillate with the emission of about 50 optical photons for every kV of energy loss, thus resulting in hundreds of thousands of optical light quanta after each neutron capture.

As a consequence, the detector disclosed by Grodzins is emitting light quanta to both sides of the neutron scintillator sheet. The detector itself then measures the coincidence of the light detection on both sides of the neutron scintillator sheet. Such a coincident measurement is seen as a signature for a neutron-capture in neutron scintillation sheet. This detector is discriminating against gamma radiation, as a gamma quant would be stopped in the gamma scintillator only, which is optically separated from the other light guide.

Apart from the complicated setup, the Grodzins disclosure has the disadvantage that it cannot discriminate neutron events against cosmic background radiation and other energetic charged particle radiation, which may cause scintillation within the neutron absorber material or Cerenkov light in the light guides, followed by a light emission into both light guides also.

Another disadvantage of the Grodzins disclosure is an unsatisfactory neutron-gamma discrimination in case of using ¹¹³Cd or ¹⁵⁷Gd as neutron capture materials. In this case, the detector is sensitive to external gammas as well. Pulses generated by detecting external gamma radiation in the neutron scintillator cannot be distinguished from pulses due to gammas produced by neutron capture reactions.

Reeder, Nuclear Instruments and Methods in Physics Research A 340 (1994) 371, proposes a neutron detector made of Gadolinium Oxyorthosilicate (GSO) surrounded by plastic scintillators operated as total gamma absorption spectrometer in coincidence with the GSO. As plastic scintillator are distinguished by a large attenuation length for energetic gamma rays, the proposed total absorption spectrometer would either be quite inefficient or would require large volumes of plastic scintillator. A further disadvantage is that there are difficulties when collecting the light from the plastic material with a reasonable number of photodetectors. In addition, large plastic layers not only moderate but also absorb a part of the neutron flux, thus reducing the neutron detector efficiency. A further disadvantage is that background, due to Compton scattering of gamma rays from an external source in the neutron detector, followed by an interaction of the scattered gamma with the gamma detector, cannot be eliminated.

Another neutron detector utilizing a gamma ray scintillator is disclosed by Bell in U.S. Pat. No. 6,011,266. Bell is using a gamma ray scintillator, surrounded by a neutron sensitive material, preferably comprising boron. The neutron capture reaction results in fission of the neutron sensitive material into an alpha-particle and a ⁷Li ion, whereby the first excited state of the lithium ion decays via emission of a single gamma ray at 478 keV which is then detected by the scintillation detector. At the same time, the detector disclosed in Bell is sensible to gamma rays, resulting from an incident radiation field, as the neutron sensitive material is not acting as a shield against gamma rays.

One of the disadvantages of such a detector is that the single gamma ray following the decay of the first excited state of ⁷Li lies within an energy region, where a lot of other gamma rays are present. It is, therefore, necessary to measure this single decay very accurately in order to achieve at least reasonable results, thus increasing the technical complexity and the related costs substantially. Furthermore, a discrimination against charged particle radiation, for example such of cosmic origin, is difficult if not impossible with a detector as disclosed by Bell.

In summary, none of the known neutron detector concepts is competitive with a ³He tube if decisive parameters like neutron detection efficiency per volume, neutron detection efficiency per cost, gamma suppression factor, simplicity and ruggedness and availability of detector materials are considered simultaneously.

### SUMMARY OF THE INVENTION

One of the purposes of the invention is to overcome the disadvantages of the prior art and to provide an efficient neutron detector with a simple setup and a high confidentiality of neutron detection.

An aspect of the invention an apparatus for detecting neutron radiation, preferably thermal neutrons, comprising at least one first section with a high neutron absorption capability and at least one second section with a low neutron absorption capability, the second section comprising a gamma ray scintillator, the gamma ray scintillator material comprising an inorganic material with an attenuation length of less than 10 cm, preferably less than 5 cm for gamma rays of 5 MeV energy in order to provide for high gamma ray stopping power for energetic gamma rays within the second section. The material of the first section is selected from a group of materials, releasing the energy deployed in the first section by neutron capture mainly via gamma radiation, and the second section is surrounding the first section in a way that a substantial portion of the first section is covered by the second section. The apparatus is further comprising a light detector, optically coupled to the second section in order to detect the amount of light in the second section, and an evaluation device coupled to the light detector, said device being able to determine the amount of light, detected by the light detector for one scintillation event, that amount being in a known relation to the energy deployed by gamma radiation in the second section. The evaluation device is configured to classify detected radiation as neutrons when the measured total gamma energy Eₛᵤₘ is above 2,614 MeV. The evaluation device may further be configured to classify detected radiation as neutrons only when the measured total gamma energy is below a predetermined threshold, preferably below 10 MeV in addition.

According to an aspect of the invention, the first section is preferably comprising Cadmium (Cd), Samarium (Sm), Dysprosium (Dy), Europium (Eu), Gadolinium (Gd), Iridium (Ir), Indium (In) or Mercury (Hg), the second section preferably Lead Tungstate (PWO), Calcium Tungstate (CaWO₄), Bismuth Germanate (BGO), Sodium Iodide (Nal), Caesium Iodide (CsI), Barium Flouride (BaF₂), Lead Flouride (PbF₂), Cerium Flouride (CeF₂), Calcium Flouride (CaF₂) or scintillating glass materials.

In a further embodiment, the second section is surrounding the first section in a way that more than half of the sphere (2π) is covered by the second section.

According to an aspect of the invention, the first section comprises a neutron scintillator, selected in a way that it has a sufficient gamma capture cross section to measure gamma energies of up to at least 100 keV, up to at least 500 keV, with sufficient efficiency.

According to an aspect of the invention, the evaluation device is configured to classify detected radiation as neutrons when at least one gamma event is measured by the neutron scintillator in addition.

According to an aspect of the invention, when no signal in the first section has a measured energy above a predetermined threshold. This threshold is being determined by measuring the thickness d (in cm) of the scintillator in the first section, then determining the energy Eₘᵢₙ (in MeV) corresponding to the energy deposition of minimum ionizing particles covering a distance d in said scintillator and by multiplying said thickness with the density of the scintillator material, given in g/cm³, and with the energy loss of minimum ionizing particles in said scintillator, given in MeV/(g/cm²). The threshold is then set below said energy.

In yet another embodiment, the light detector is mounted in a way that both, the light of the gamma ray and the neutron scintillator propagate to the same light detector. Preferably, the materials for the neutron and the gamma ray scintillator are selected from a group so that their emitted light has different timing characteristics, for example the light is emitted with different decay times. The evaluation device may then be configured in a way that it is capable to distinguish the light with the different characteristics emitted by the respective scintillators from a single light detector signal, comprising the light components of both scintillators. The materials for the neutron and the gamma ray scintillator may further be selected from a group so that they have similar emission wave lengths and similar light refraction indices. Furthermore, the first and the second section may be commonly arranged in one detector, mounted to a common light detector so that the second section is split by the first section into at least two parts, only one part of the second section being optically coupled to the light detector.

According to an aspect of the invention, the material of the first section comprises Cadmium Tungstate (CWO) and the material of the second section Lead Tungstate (PWO) or the material of the first section is comprising Gadolinium Oxyorthosilicate (GSO) based materials and the material of the second section comprising Sodium Iodide (Nal) or Caesium Iodide (CsI) based scintillators.

In yet another embodiment, the second section may comprise at least three gamma ray scintillators, each gamma ray scintillator being coupled to a light detector so that the signals from the different gamma scintillators can be distinguished. As a specific embodiment, the first and the second section are commonly arranged in one detector so that the second section is split by the first section at least into three parts, all parts being optically coupled to different light detectors so that the light from the parts can be evaluated separately. Ideally, the evaluation device is configured to classify detected radiation as neutrons when at least two gamma ray scintillators have detected a signal being due to gamma interaction, following a neutron capture in the first section.

According to an aspect of the invention, the parts of the second section as described in the previous paragraph may form several more or less integral parts of a single detector or, as an alternative, may comprise at least three individual gamma ray scintillators, the signals of which being commonly evaluated as described above.

An alternative is an apparatus where the first and the second section are commonly arranged in one detector, mounted to a common light detector so that the second section is split by the first section into two parts, both parts being optically coupled to the light detector. It is even a further advantage when the second section is split by the first section at least into three parts, all parts being optically coupled to the light detector.

According to another embodiment, the first section is mounted at the outer sphere of the second section.

According to an aspect of the invention, the apparatus comprises a third section, so that the first and the second section are in part commonly surrounded by said third section, said third section comprising a scintillator, the emission light of said scintillator being measured by a light detector, where the output signals of the light detector are evaluated by the common evaluation device of the apparatus. In a specific embodiment, the evaluation device is configured to classify detected radiation as neutrons when no signal with an energy of above a certain shield threshold has been detected from the third section scintillator in the same time frame (anti-coincidence), said shield threshold being determined in several steps. First, the thickness t (in cm) of the scintillator in the third section is measured, then, the energy Eₘᵢₙ (in MeV), corresponding to the energy deposition of minimum ionizing particles covering a distance t in said scintillator by multiplying said thickness with the density of the scintillator material, given in g/cm³, and with the energy loss of minimum ionizing particles in said scintillator, given in MeV/(g/c²), and by finally setting the shield threshold below said energy.

According to an aspect of the invention, the third section is optically coupled to the light detector of the second section and to configure the evaluation device to distinguish the signals from the second and third section by their signal properties.

According to an aspect of the invention, a wavelength shifter is mounted between the scintillator of the third section and the photo detector.

The material used for the scintillator in the third section may preferably be selected from a group of materials comprising constituents with low atomic number Z, serving as a neutron moderator for fast neutrons.

According to an aspect of the invention, a method for detecting neutrons, preferably thermal neutrons, using an inventive apparatus as described above, where, as a first step, a neutron is captured in the first section, followed by a measurement of the light emitted from the second section as a consequence of the gamma radiation energy loss, and by the determination of the total energy loss of the gamma radiation, following a neutron capture, from the light emitted from the second section of the apparatus. The measured event is then classified as neutron capture when the total energy loss measured is above 2,614 MeV. It is possible to add an upper threshold in order to classify a measured event as a neutron capture, where the total energy loss measured is required to be below a predetermined threshold, preferably below 10 MeV.

According to an aspect of the invention, the second section of which comprises at least three gamma ray scintillators, one can utilize a method for detecting neutrons, preferably thermal neutrons, comprising the steps of first capturing a neutron in the first section, then measuring the light emitted from the second section as a consequence of the gamma radiation energy loss, as a consequence determining the total energy loss of the gamma radiation, following a neutron capture, from the light emitted from the second section of the apparatus and finally classifying an event as neutron capture when the total energy loss measured is above 2,614 MeV and when an energy loss is measured in at least two of the gamma scintillators in addition.

According to an aspect of the invention, when utilizing a neutron scintillator in it's first section, one may make use of a method for detecting neutrons, preferably thermal neutrons, comprising the steps of first capturing a neutron in the first section, then measuring the light emitted from the first section as a consequence of the gamma radiation energy loss, at the same time measuring the light emitted from the second section as a consequence of the gamma radiation energy loss, and determining the total energy loss of the gamma radiation, following a neutron capture, from the light emitted from the second section of the apparatus, and classifying an event as neutron capture when the total energy loss measured in the second section is above 2,614 MeV and when an energy loss has been detected in the first section at the same time. This method may be improved by determining the total energy loss of the gamma radiation, following a neutron capture, from the light emitted from both the first and the second section of the apparatus.

According to an aspect of the invention, it is further required that the total energy loss of the gamma radiation, following a neutron capture, is below a predetermined threshold, preferably below 10 MeV.

According to an aspect of the invention, when requiring that the measured energy loss in the first section is below a predetermined threshold. That threshold is being determined by utilizing the steps of measuring the thickness d (in cm) of the scintillator in the first section, determining the energy Eₘᵢₙ (in MeV) corresponding to the energy deposition of minimum ionizing particles covering a distance d in said scintillator by multiplying said thickness with the density of the scintillator material, given in g/cm³, and with the energy loss of minimum ionizing particles in said scintillator, given in MeV/(g/cm²), and finally setting the threshold below said energy.

According to an aspect of the invention, the further discrimination against unwanted events is possible when an event is classified as external gamma radiation and therefore not as a neutron capture when an energy loss is observed in the second section but no energy loss is observed in the first section at the same time.

According to an aspect of the invention, when using a third shield section as described above, neutrons, preferably thermal neutrons, can be determined by utilizing the steps of again capturing a neutron in the first section, measuring the light emitted from the second section as a consequence of the gamma radiation energy loss, determining the total energy loss of the gamma radiation, following a neutron capture, from the light emitted from the second section of the apparatus, and classifying an event as neutron capture when the total energy loss measured is above 2,614 MeV and when no signal with an energy of above a certain shield threshold has been detected from the third section scintillator in the same time frame (anti-coincidence). Said shield threshold is determined following the steps of first measuring the thickness t (in cm) of the scintillator in the third section, then determining the energy Eₘᵢₙ (in MeV) corresponding to the energy deposition of minimum ionizing particles covering a distance t in said scintillator, by multiplying said thickness with the density of the scintillator material, given in g/cm³, and with the energy loss of minimum ionizing particles in said scintillator, given in MeV/(g/cm²), and by finally setting the shield threshold below said energy.

According to an aspect of the invention, when the total energy loss of the gamma radiation, following a neutron capture is determined from the light emitted from both the second and the third section. In addition, an event may be classified as neutron capture only when the total energy loss of the gamma radiation, following a neutron capture, is below a predetermined threshold, preferably below 10 MeV. On the other hand, an event may be classified as an external gamma radiation, therefore not being a neutron capture event, when an energy loss below the shield threshold is observed in section three but no energy loss is observed in the second section.

According to an aspect of the invention, a method for detecting neutrons, preferably thermal neutrons, using an inventive apparatus with a surrounding third (shield) section, the first section comprising a neutron scintillator, utilizing the steps of capturing a neutron in the first section, measuring the light emitted from the first section as a consequence of the gamma radiation energy loss, measuring the light emitted from the second section as a consequence of the gamma radiation energy loss, and determining the total energy loss of the gamma radiation, following a neutron capture, from the light emitted from the second section of the apparatus. According to that method, an event is classified as neutron capture when the total energy loss measured in the second section is above 2,614 MeV, and when an energy loss has been detected in the first section at the same time and when no signal with an energy of above a certain shield threshold has been detected from the third section scintillator in the same time frame (anti-coincidence). Said shield threshold is determined according to the steps of first measuring the thickness t (in cm) of the scintillator in the third section, then determining the energy Eₘᵢₙ (in MeV) corresponding to the energy deposition of minimum ionizing particles covering a distance t in said scintillator, by multiplying said thickness with the density of the scintillator material, given in g/cm³, and with the energy loss of minimum ionizing particles in said scintillator, given in MeV/(g/cm²), and by finally setting the shield threshold below said energy.

According to an aspect of the invention, when the total energy loss of the gamma radiation, following a neutron capture is determined by adding the energy losses detected in the first and the second section or by adding the energy losses detected in the second and in the third section, or even by adding the energy losses detected in the first, second and in the third section.

According to an aspect of the invention, the discrimination against background radiation may be improved by requiring the measured total energy loss of the gamma radiation, following a neutron capture, being below a predetermined threshold, preferably below 10 MeV.

According to an aspect of the invention, a way to discriminate against background radiation is to classify an event as external gamma radiation—and not as a neutron capture event—when an energy loss is detected in section two or in section three, but no energy loss above the shield threshold in section three and no energy loss in section one at the same time. In that context, it goes without saying that “no energy loss” stands for an energy loss below the detection limit.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows an embodiment of the invention with the cylindrical scintillator and a neutron absorber layer in the middle of that scintillator as well as a light detector,

FIG. 2 shows a similar setup with two neutron capture layers.

FIG. 3 shows another embodiment with a neutron capture scintillator, dividing two parts of the scintillator material.

FIG. 4 shows the inventive detector with a surrounding shield detector,

FIG. 5 shows a similar detector, using just one single light detector, and

FIG. 6 shows the various decay times of signals, emitted from different scintillator materials.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

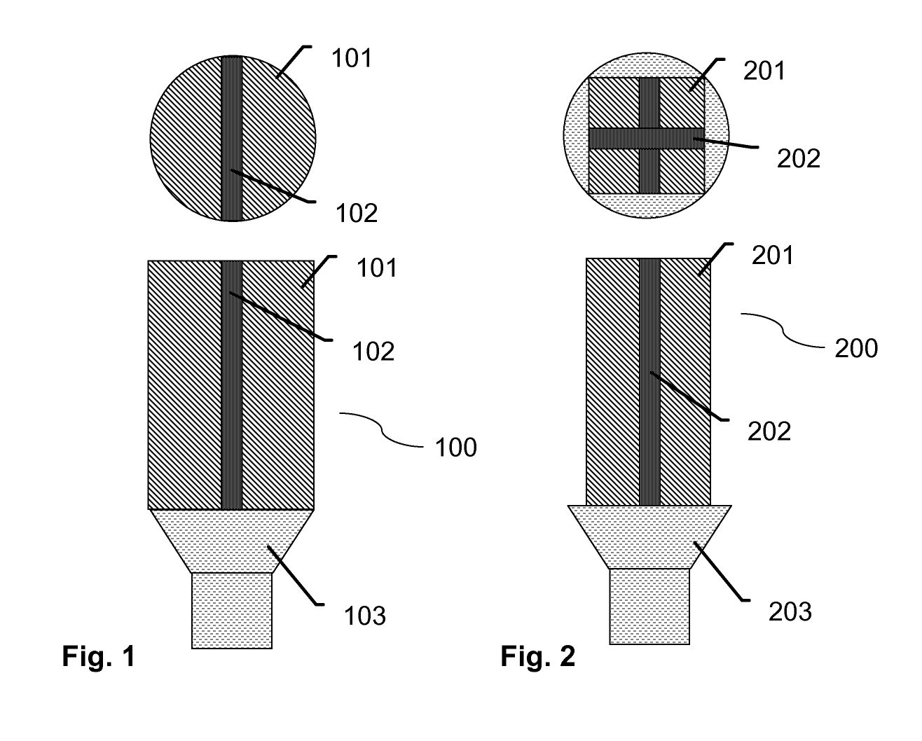

FIG. 1 shows, in it's lower section, a longitudinal cut through an embodiment. The detector 100 and three of its main sections are shown here. A gamma scintillator material 101 can be seen, which is mounted on a light detector 103, preferably a photo multiplier tube or an array of Geiger-mode avalanche photodiodes (G-APD). This gamma scintillator material is, along its longitudinal axis, split in two parts, whereby the neutron capture material 102 is arranged in between the two parts of the gamma scintillator. The position of the neutron capture material 102 can be seen prominently in the lateral cut through the scintillator material, shown in the upper part of FIG. 1.

The gamma scintillator material is selected in a way that its' neutron capture cross section for thermal (slow) neutrons is low, thus letting pass most of the neutrons through the scintillator material without neutron capture.

The neutron capture section 102 located in the center of the detector is a sheet of material with a high cross section for neutron capture, that is with a high neutron absorption capability. This section 102 is preferably more or less transparent for gamma rays.

Different from what is known from the prior art, the neutron capture material of the first section 102 is not a material, which substantially leads to fission or the emission of charged particles once the neutron has been captured, but is mainly releasing its excitation energy via gamma ray emission. Appropriate materials are, for instance, materials containing Gadolinium (Gd), Cadmium (Cd), Europium (Eu), Samarium (Sm), Dysprosium (Dy), Iridium (Ir), Mercury (Hg), or Indium (In). As every neutron capture deposits a considerable amount of excitation energy, mostly about 5 to 10 MeV, in the nucleus, depending on the capturing nuclide, this is roughly the energy which is released in form of multiple gamma quanta with energies ranging from a few keV up to some MeV. Contrary to that, the usual neutron capture reaction used in state of the art detectors lead to an energy release mostly by the emission of fission products and/or charged particles. Those processes are also often accompanied by gamma radiation, which, nevertheless, amounts only to a smaller part of the total energy release.

The inventive apparatus utilizes a neutron capture, followed by the release of gamma quanta with a total energy somewhere in between 5 to 10 MeV. As a consequence, the novel detector concept with an efficient gamma scintillator allows to measure a substantial portion of those gamma quanta emitted and so to sufficiently discriminate events following neutron capture against radiation background, in particular against gamma radiation due to most radioactive decays.

It has to be noted that the gamma cascades following a neutron capture are emitted very fast so that the single gamma events can not be distinguished by the gamma scintillator 101. Therefore, the gamma scintillator 101 as such is summing up all gamma energies, producing an amount of light, which is mostly proportional to the total energy Eₛᵤₘ deposed in the scintillator material. The scintillator, therefore, cannot distinguish between a single high energy gamma and a multitude of lower energy gamma rays, absorbed in the same time window.

The gamma scintillator 101 is therefore designed to operate as a kind of calorimeter, thus summing up all energy deposited after a single neutron capture event. It is constructed and arranged in a way that maximizes the portion of the sum energy Eₛᵤₘ which is on average absorbed in the scintillation material, following a neutron capture in the neutron absorber, at minimum cost and minimum detector volume. Considering that, depending on the specific reaction used, only a part of the sum energy Eₛᵤₘ is in fact absorbed, it is advantageous to define an appropriate window, in other words a sum energy gate, in the detector. Only events with a sum energy Eₛᵤₘ within that window would then be identified as neutron captures with a sufficient certainty.

The evaluation device, not shown here, evaluating the signal output from the light detector 103, is set to define an event as neutron capture when the sum energy Eₛᵤₘ is larger than 2,614 MeV. With this condition for a lower threshold, the invention makes use of the fact that the highest single gamma energy resulting from one of the natural radioactive series has exactly 2,614 MeV, which is the gamma decay in ²⁰⁸TI, being part of the natural thorium radioactive series.

As it is highly unlikely to measure two independent gamma rays from two sources in coincidence, the threehold of 2,614 MeV is good enough to discriminate against natural or other background radiation.

It is worth noting that such a gamma calorimeter is an efficient detector for neutron capture gamma rays produced outside of the detector as well. This could improve the sensitivity of the inventive apparatus for detecting neutron sources. This is due to the fact that all materials surrounding a neutron source capture neutrons to more or less extent, finally capturing all the neutrons produced by the source. Those processes are mostly followed by emission of energetic gammas, often with energies well above 3 MeV. Those gamma rays may contribute to the neutron signals in the inventive detector if they deposit a sufficient part of their energy in section two of the apparatus.

In order to operate the gamma scintillator in a calorimetric regime, it is advantageous to choose the size of the scintillator in dependence from the scintillator material in a way that a substantial portion of the gamma rays emitted after neutron capture can be stopped in the gamma scintillator. A very suitable material, for example, is Lead Tungstate (PWO or PbWO₄) as this material is distinguished by a striking stopping power for the gamma energies of interest, including the highest gamma energies. The low light output (in photons per MeV) of PWO is acceptable with this application, because it does not require surpassing spectrometric performance. An also important aspect is that this material is easily available in large quantities for low cost.

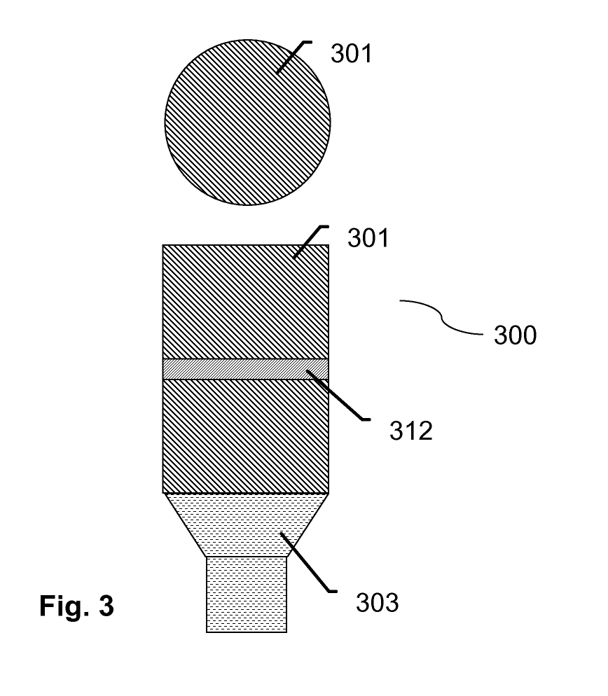

It is advisable to use PWO scintillator materials with a diameter around 5 to 8 centimeters for section two. In combination with a setup shown in FIG. 1 and FIG. 2, such a detector is able to absorb more than 3 MeV of gamma energy in more than 50% of all cases when gamma rays with an energy above 4 MeV are produced in the neutron capture material (section one).

The first (neutron) and the second (gamma) section of the detector are preferably arranged in a way that the gamma ray scintillator section covers at least half of the sphere (2π) of the neutron capturing first section and is preferably more or less completely surrounding said first section in order to provide for a high detection efficiency for those gamma rays emitted after neutron capture in the first section.

It may also be advisable to set a further, upper threshold for the sum energy Eₛᵤₘ at about 10 MeV. The total energy emitted after neutron capture usually does not exceed this value. Nevertheless, signals with energy signatures above that threshold may occur, following the passage of cosmic radiation, for example muons, through the gamma scintillator, especially when the detector is relatively large. Those events are discriminated and suppressed by the said threshold. Actually both, the lower and the upper, thresholds for the energy deposition in section two should be optimized in a way that the effect-to-background ratio is optimized for the scenario of interest.

In an embodiment, the first section 102 of the detector comprises a neutron scintillator material, preferably being transparent for scintillator photons.

This embodiment may further make use of the fact that the neutron scintillator, like any scintillator, is also absorbing gamma quanta to a certain extent, by using this information for further evaluation. In order to do so it is necessary to distinguish the light, being emitted after gamma absorption in the neutron scintillator, from the light emitted after a gamma absorption in the gamma ray scintillator. This can be done easily with a single photodetector if the scintillation materials are selected in a way that the light decay time and/or the frequency of the emitted light in the two scintillators is different.

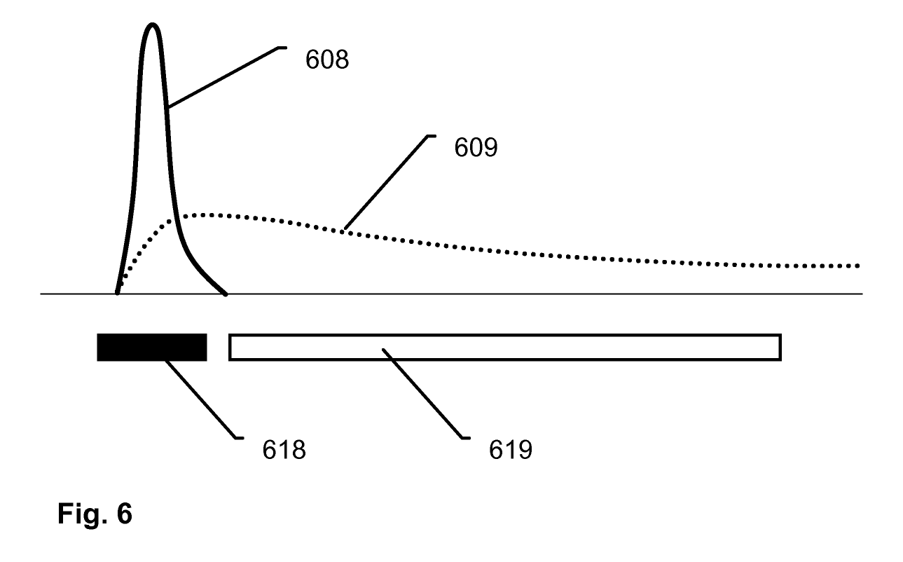

An example of the respective signals with different decay time is shown in FIG. 6. Pulse 608 is, for example, resulting from the gamma ray scintillator, providing a scintillation material with a short decay time. When the decay time of the light, emitted from the neutron scintillator is much larger, as shown by the dashed line 609 in FIG. 6, those signals could easily be distinguished either digital signal processing or by simply setting two timing windows 618 and 619 on the signal output of the light detector.

It is possible to separate the neutron and the gamma ray scintillator optically for the scintillation light. Nevertheless, for some applications it is especially preferable, when both, the emission wave length of the neutron scintillator and the refraction index of the neutron scintillator are similar to the corresponding values of the gamma scintillator. In case those conditions are met, the first and second section of the apparatus, that is the neutron scintillator and the gamma scintillator, are optically acting similarly and can be joined to just one block of scintillator, thus making the detection of the light in the light detector 103 easier and more efficient.

The sum energy Eₛᵤₘ is usually measured in the gamma ray scintillator by collecting and measuring the light produced in the gamma ray scintillator, using a light detector 103, and evaluating the measured signal from the light detector. The energy released by gamma rays in the neutron scintillator, Eₙ, is measured separately and in addition. If the neutron scintillator is sufficiently efficient to absorb part of the gamma energy released in the neutron capture, this allows to improve the neutron identification and background suppression by requiring more conditions for a neutron to be detected.

The first neutron detection criterion is generally a sum energy Eₛᵤₘ higher than 2,614 MeV.

The second criterion is a signal detected in the neutron scintillator. The reason is that most neutron capture events in the inventive detector are followed by gamma cascades, i.e., by emission of multiple gamma rays including low-energy gammas below 500 keV or even below 100 keV, which interact with high probability in scintillators of a few millimeters thickness. A signal in the neutron scintillator is therefore a good indicator of a neutron capture event. It has to be noted that the efficiency of the detector system for neutron capture events is not much affected by such an additional criterion, as the neutron capture takes place within the neutron scintillator, the neutron scintillator itself being the source of the gamma radiation. This includes low energy gamma radiation where the neutron scintillator has a high stopping power. Therefore, there is a high probability that the neutron scintillator detects at least one gamma event following a neutron capture within the first section.

A third useful criterion may be an upper limit to the gamma energy Eₙ deployed in the neutron scintillator, in order to suppress background due to penetrating cosmic radiation. In scintillators of a few millimeter thickness the probability of depositing more than 1-2 MeV of the gamma energy due to the neutron capture is rather small. On the other hand penetrating cosmic particles may deposit a considerable amount of kinetic energy in such a scintillator. The minimum energy deposition of penetrating charged particles (in MeV) is given by the detector thickness (given in centimeters), multiplied with the density of the scintillator (given in grams per cubic centimeter) and with the energy loss of so called minimum ionizing particles (mips) in the corresponding scintillator material (given in MeV per gram per square centimeter). The latter is larger than 1 MeV/(g/cm²) for all common materials, which allows an easy estimate of the said upper limit. Using a 0,5 cm Cadmium Tungstate (CWO) scintillator as neutron scintillator, for instance, does result in a lower limit of about 0,5 7,8 1 MeV or about 3,9 MeV for the energy deposition of charged particles crossing the neutron scintillator. This value has to be taken as an upper limit for a neutron capture signal in the neutron scintillator; larger signals are expected to be caused by energetic (cosmic) background and would have to be rejected.

It is worth mentioning that, when the second criterion is used for identifying neutron capture events, a missing signal in section one at the time when a signal is obtained from section two could be taken as a signature for the detection of an external gamma ray in section two, thus using the inventive detector as a detector (or spectrometer) for external gamma rays in parallel.

The efficiency of the detector system may be increased by looking at the whole scintillator, that is the combination of the first (neutron) and the second (gamma) section as a single gamma scintillator, thereby adding the energy deployed in the gamma ray scintillator and the energy deployed in the neutron scintillator and using this combined value as the sum energy

Eₛᵤₘ.

Another embodiment 200 is shown in FIG. 2. Here the gamma ray scintillator 201 is split into four parts, divided by the neutron detector 202. Again the scintillator is mounted on a light detector 203.

When using a neutron scintillator material as a neutron detector, especially when this scintillator material has a refraction index similar to the refraction index of the gamma scintillator material, further embodiments are possible.

An example is shown in FIG. 3, where gamma scintillator material 301 is divided in two sections perpendicular to the longitudinal axis by a neutron scintillator 312.

As all the scintillator material has a substantially identical reflection index, the light, following from gamma capture in the upper part of the second section is able to pass through the neutron scintillator material 312 in the center part of the detector 300 without much loss, so that it still can be detected by the light detector 303.

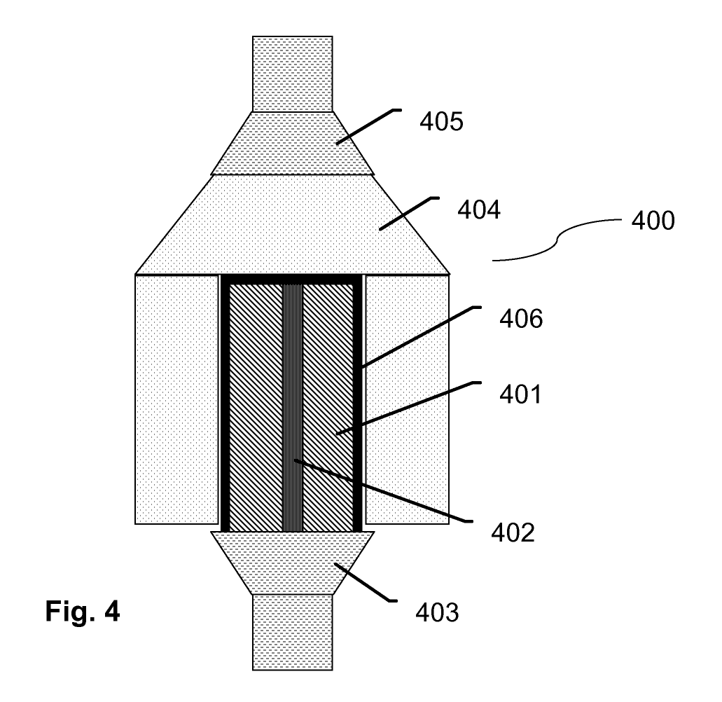

Yet another embodiment of the invention is shown in FIG. 4. In the center, an apparatus as described in the first embodiment is to be seen, consisting of the first section 402, capturing neutrons, the second gamma ray scintillator section 401 and the light detector 403. This detector may optionally be encapsulated with a material 406. The whole scintillator portion of the detector is surrounded by a third section 400, also comprising scintillator material 404. The light generated in this scintillator material is detected by an additional light detector 405.

This outer detector 400 preferably serves as anti-coincidence shield against background radiation, for example cosmic radiation. When the third section 400 is making use of a scintillator material with fairly low atomic numbers, it may also serve as a moderator for fast neutrons at the same time, thus allowing the apparatus to detect fast neutrons also. In this context it has to be mentioned that also the encapsulating material 406 of the detector may be selected in a way that this material serves as a neutron moderator, whereas such a selection of material is not limited to the embodiment with a surrounding third section 400, but may also be used in combination with the other embodiments.

In an embodiment, the outer scintillator material 404 of the third section comprises plastic scintillator material. Such material is easily available and easy to handle.

The minimum energy deposition of penetrating charged particles in the scintillator of section three (in MeV) is given by the scintillator thickness (given in centimeters), multiplied with the density of the scintillator (given in grams per cubic centimeter) and with the energy loss of minimum ionizing particles (mips) in the corresponding scintillator material (given in MeV per gram per square centimeter). The latter is larger than 1 MeV/(g/cm²) for all common materials' and larger than 1,5 MeV/(g/cm²) for all light materials, which allows an easy estimate of the said upper limit. For example, using a 2 cm Plastic (PVT) scintillator in the third (shield) section, for instance, would result in an lower limit of about 2 1 1,5 MeV or about 3 MeV for a signal due to penetrating charged particles in the shield section. Those signals would have to be rejected as background. In this case, the anti-coincidence condition for the outer third section could be that no energy has been detected in the third section of more than 3 MeV.

As a consequence, an energy detected in the outer third section of the apparatus of less than 3 MeV in the specific example, is likely not to origin from energetic cosmic radiation so that such a lower energy event, if detected in coincidence with gamma rays in the second section, could be added to the sum energy Eₛᵤₘ as it may have its origin in the neutron capture within the first section. If this signal is, however, actually due to external gamma radiation, the sum energy condition (Eₛᵤₘ>2614 keV) would reject the corresponding event.

It is worth mentioning that, when an energy deposition is observed in the third section which is smaller than the minimum energy deposition of penetrating charged particles, while no signal is observed in section one or two at the same time, this could be taken as a signature for the detection of an external gamma ray in section three, thus using the shield scintillator as a detector (or spectrometer) for (external) gamma rays in parallel.

In a similar way, an energy deposition in the third section of less than the minimum energy deposition of penetrating charged particles, accompanied by a signal in section two while no signal is observed in section one at the same time could be taken as a signature for the detection of an external gamma which deposits energy in both sections two and three due to

Compton scattering followed by a second scattering act or photo absorption. Therefore the combination of section two and three could be operated as a detector (or spectrometer) for external gamma rays, while the neutron scintillator of section one allows discriminating the neutron capture events.

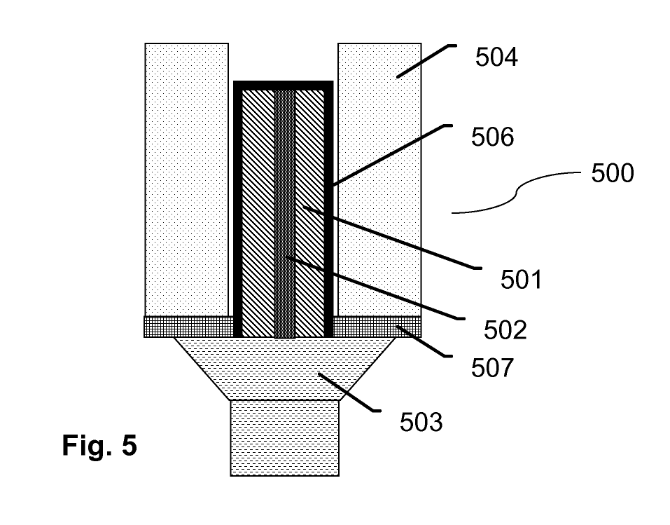

A further improvement of said shield detector variant is shown in FIG. 5. Again, a gamma ray scintillator 501 and a neutron absorbing detector 502 are mounted on a light detector 503. A gamma ray scintillator may again be surrounded by some kind of encapsulation 506.

Different from the other embodiments, the light sensitive surface of the light detector 503 is extending across the diameter, covered by the gamma ray detector 501. This outer range of the light detector 503 is optically coupled to a circular third section, preferably again a plastic scintillator 504, surrounding the first and second section of the detector.

In order to properly distinguish the signal originating from the gamma ray scintillator 501 from the signals originating from the plastic scintillator 504, a wavelength shifter 507 maybe added. Such a wavelength shifter preferably absorbs the light from the plastic scintillator material 504, emitting light with a wave length similar to the wave length emitted from the gamma ray scintillator 501 so that it can be properly measured by the same light detector 503. In order to distinguish signals from the plastic scintillator 504 from those of the gamma ray scintillator 501, it is an advantage if the light, emitted from the wave length shifter 507 has a different decay time, thus allowing the evaluation device to clearly distinguish between the two signal sources as described above.

It is not essential that section two comprises a single gamma scintillator material arranged in a single detector block read out with a common photodetector. In another embodiment the gamma calorimeter consists of multiple individual detectors, which could be based on different scintillator materials, and read out by individual photodetectors. This embodiment is of advantage if detectors originally designed for another purpose, e.g. detection and spectroscopy of external gamma radiation can be involved in the calorimeter in order to reduce the total expense.

Yet another feature of the invention is the possibility to utilize the high multiplicity of the gamma rays emitted after a neutron capture in the neutron capturing first section. If the second section, the gamma ray scintillator, is set up in a way that it comprises three or more detectors, the multiplicity maybe evaluated also.

A setup as shown in FIG. 2 would allow splitting the second section in four different parts, as the gamma ray scintillator is divided into four parts. If the light detector is split in a way that the light of the four gamma ray scintillators can be distinguished, for instance by using multi-anode photomultiplier tubes (not shown in FIG. 2), it can also be evaluated separately. Therefore, in addition to measuring the sum energy Eₛᵤₘ, it is also possible to require a certain multiplicity of the measured gamma events.

Taking into account the limited efficiency of the detectors, it has proven to be an advantage to require at least two parts of the second section, that is two different parts of the gamma ray scintillator as shown in FIG. 2, having detected gamma events. Especially in addition to the sum energy condition Eₛᵤₘ larger than 2,614 MeV this multiplicity condition further increases the accuracy of the inventive detector.

Summarizing the above, the invention claimed does provide a low cost, easy to set up detector, which is based on well known, inexpensive, of-the-shelf scintillator materials and well known, inexpensive, of-the-shelf photodetectors, and a method for evaluating the emitted signals with an efficiency and accuracy comparable to the state of the art ³He-counters.

Although a few embodiments of the present invention have been shown and described, it would be appreciated by those skilled in the art that changes may be made in this embodiment without departing from the principles and spirit of the invention, the scope of which is defined in the claims and their equivalents.

1. An apparatus for detecting neutron radiation comprising:
at least one first section with a high neutron absorption capability;
at least one second section with a low neutron absorption capability, the second section comprising a gamma ray scintillator comprising a gamma ray scintillator material comprising an inorganic material with an attenuation length of less than 10 cm for gamma rays of 5 MeV energy in order to provide for high gamma ray stopping power for energetic gamma rays within the second section
a light detector, optically coupled to the second section in order to detect the amount of light in the second section; and
an evaluation device coupled to the light detector and which determines the amount of light, detected by the light detector for one scintillation event, the amount being in a known relation to the energy deployed by gamma radiation in the second section,
wherein:
the material of the first section is selected from a group of materials which release the energy deployed in the first section by neutron capture mainly via gamma radiation,
the second section surrounds the first section in a way that a substantial portion of the first section is covered by the second section, and
the evaluation device is configured to classify detected radiation as neutrons when the measured total gamma energy Eₛᵤₘ is above 2,614 MeV.

2. The apparatus of claim 1, wherein the evaluation device is configured to also classify detected radiation as neutrons when the measured total gamma energy is below a predetermined threshold.

3. The apparatus of claim 1, wherein the first section comprises Cadmium (Cd), Samarium (Sm), Dysprosium (Dy), Europium (Eu), Gadolinium (Gd), Iridium (Ir), Indium (In) or Mercury (Hg).

4. The apparatus of claim 1, where the material for the second section is selected from a group of Lead Tungstate (PWO), Calcium Tungstate (CaWO₄), Bismuth Germanate (BGO), Sodium Iodide (Nal), Caesium Iodide (CsI), Barium Flouride (BaF₂), Lead Flouride (PbF₂), Cerium Flouride (CeF₂), Calcium Flouride (CaF₂) and scintillating glass materials.

5. The apparatus of claim 1, where the second section is surrounds the first section in a way that more than half of the sphere (2π) is covered by the second section.

6. The apparatus of claim 1, where the first section comprises a neutron scintillator.

7. The apparatus of claim 6, where the neutron scintillator is selected in a way that it has a sufficient gamma capture cross section to measure gamma energies of up to at least 100 keV, preferably up to at least 500 keV, with sufficient efficiency.

8. The apparatus of claim 7, where the evaluation device is configured to also classify detected radiation as neutrons when at least one gamma event is measured by the neutron scintillator.

9. The apparatus of claim 8, where no signal in the first section has a measured energy above a predetermined threshold, threshold being determined by:
measuring the thickness d (in cm) of the scintillator in the first section,
determining the energy Eₘᵢₙ (in MeV) corresponding to the energy deposition of minimum ionizing particles covering a distance d in said scintillator, by multiplying said thickness with the density of the scintillator material, given in g/cm³, and with the energy loss of minimum ionizing particles in said scintillator, given in MeV/(g/cm²), and
setting the threshold below said energy.

10. The apparatus of claim 8, where the light detector is mounted in a way that both the light of the gamma ray and the neutron scintillator propagate to the came light detector.

11. The apparatus of claim 10, where the materials for the neutron and the gamma ray scintillator are selected from a group so that their emitted light has different timing characteristics.

12. The apparatus of claim 11, where the evaluation device capable of distinguishing the light with the different characteristics emitted by the respective scintillators from a single light detector signal, comprising the light components of both scintillators.

13. The apparatus of claim 12, where the materials for the neutron and the gamma ray scintillator are selected from a group so that the materials have similar emission wave lengths and similar light refraction indices.

14. The apparatus of claim 13, where the first and the second section are commonly arranged in one detector, mounted to the light detector so that the second section is spilt by the first section into at least two parts, only one part of the second section being optically coupled to the light detector.

15. The apparatus of claim 13, wherein the material of the first section comprises Cadmium Tungstate (CWO), and the material of the second section comprises Lead Tungstate (PWO).

16. The apparatus of claim 13, wherein
the material of the first section comprises comprising Gadolinium Oxyorthosilicate (GSO) based materials, and
the material for the second section comprises Sodium Iodide (Nal) or Caesium Iodide (Csl) based scintillators.

17. The apparatus of claim 1, wherein the second section comprises at least three gamma ray scintillators, each gamma ray scintillator being coupled to a light detector so that the signals from the different gamma scintillators can be distinguished.

18. The apparatus of claim 1, where the first and the second section are commonly arranged in one detector so that the second section is spilt by the first section at least into three parts, all parts being optically coupled to different light detectors so that the light from the parts can be evaluated separately.

19. The apparatus of one claim 17, where the evaluation device is configured to classify detected radiation as neutrons when at least two gamma ray scintillators have detected a signal being due to gamma interaction, following a neutron capture in the first section.

20. The apparatus of claim 1, where the first and the second section are commonly arranged in one detector, mounted to a common light detector so that the second section is spilt by the first section into two parts, both parts being optically coupled to the light detector.

21. The apparatus of claim 20, where the second section is spilt by the first section at least into three parts, all three parts being optically coupled to the light detector.

22. The apparatus of claim 1, where the first section is mounted at the outer surface of the second section.

23. The apparatus of claim 1, where the first and the second section are in part commonly surrounded by a third section, said third section comprising a scintillator, the emission light of said scintillator being measured by the light detector, where the output signals of the light detector are evaluated by the common evaluation device of the apparatus.

24. The apparatus of claim 23, where the evaluation device is configured to classify detected radiation as neutrons when no signal with an energy of above a certain shield threshold has been detected from the third section scintillator in the same time frame (anti-coincidence), said shield threshold being determined according to the following method:
measuring the thickness t (in cm) of the scintillator in the third section,
determining the energy Eₘᵢₙ (in MeV) corresponding to the energy deposition of minimum ionizing particles covering a distance t in said scintillator, by multiplying said thickness with the density of the scintillator material, given in g/cm³, and with the energy loss of minimum ionizing particles in said scintillator; given in MeV/(g/cm²), and
setting the shield threshold below said energy.

25. The apparatus of claim 24, wherein
the third section is optically coupled to the light detector of the second section, and
the evaluation device is configured to distinguish the signals from the second and third section by their signal properties.

26. The apparatus of claim 25, where a wavelength shifter is mounted in between the scintillator of the third section and the light detector.

27. The apparatus of claim 23, where the scintillator is selected from a group of materials comprising constituents with low atomic number Z, serving as a neutron moderator for fast neutrons.

28. A method for detecting neutrons using the apparatus of claim 1, the method comprising:
capturing a neutron in the first section;
measuring the light emitted from the second section as a consequence of the gamma radiation energy loss;
determining the total energy loss of the gamma radiation, following a neutron capture, from the light emitted from the second section of the apparatus, and
classifying an event as neutron capture when the total energy loss measured is above 2,614 MeV.

29. The method according to claim 28, where an event is classified as neutron capture only when the total energy loss measured is below a predetermined threshold.

30. A method for detecting neutrons, using the apparatus of claim 17, the method comprising:
capturing a neutron in the first section;
measuring the light emitted from the second section as a consequence of the gamma radiation energy loss;
determining the total energy loss of the gamma radiation, following a neutron capture, from the light emitted from the second section of the apparatus; and
classifying an event as neutron capture when the total energy loss measured is above 2,614 MeV and when an energy loss is measured in at least two of the gamma scintillators.

31. A method for detecting neutrons using the apparatus of claim 6, the method comprising:
capturing a neutron in the first section;
measuring the light emitted from the first section as a consequence of the gamma radiation energy loss;
measuring the light emitted from the second section as a consequence of the gamma radiation energy loss;
determining the total energy loss of the gamma radiation, following a neutron capture, from the light emitted from the second section of the apparatus; and
classifying an event as neutron capture when the total energy loss measured in the second section is above 2,614 MeV and when an energy loss has been detected in the first section at the same time.

32. The method according to claim 31, where the total energy loss of the gamma radiation, following a neutron capture, is determined from the light emitted from both the first and the second section of the apparatus.

33. The method according to the claim 31, where the total energy loss of the gamma radiation, following a neutron capture.

34. The method according to claim 31, wherein the measured energy loss in the first section is below a predetermined threshold, said threshold being determined according to the following method:
measuring the thickness d (in cm) of the scintillator in the first section,
determining the energy Eₘᵢₙ, (in MeV) corresponding to the energy deposition of minimum ionizing particles covering a distance d in said scintillator, by multiplying said thickness with the density of the scintillator material, given in g/cm³, and with the energy loss of minimum ionizing particles in said scintillator, given in MeV/(g/cm²), and
setting the threshold below said energy.

35. The method according to claim 31, where an event is classified as external gamma radiation when an energy loss is observed in the second section but no energy loss is observed in the first section at the same time.

36. A method for detecting neutrons, using the apparatus of claim 23, the method comprising:
capturing a neutron in the first section;
measuring the light emitted from the second section as a consequence of the gamma radiation energy loss;
determining the total energy loss of the gamma radiation, following a neutron capture, from the light emitted from the second section of the apparatus; and
classifying an event as neutron capture when the total energy loss measured is above 2,614 MeV and when no signal with an energy of above a certain shield threshold has been detected from the third section scintillator in the same time frame (anti-coincidence), said shield threshold being determined according to the following method:
measuring the thickness t (in cm) of the scintillator in the third section,
determining the energy Eₘᵢₙ (in MeV) corresponding to the energy deposition of minimum ionizing particles covering a distance t in said scintillator, by multiplying said thickness with the density of the scintillator material, given in g/cm³, and with the energy loss of minimum ionizing particles in said scintillator, given in MeV/(g/cm²), and
setting the shield threshold below said energy.

37. The method according to claim 36, where total energy loss of the gamma radiation, following a neutron capture is determined from the light emitted from both the second and the third section.

38. The method according to claim 36, where an event is classified as neutron capture only when the total energy loss of the gamma radiation, following a neutron capture, is below a predetermined threshold.

39. The method according to claim 36, where an event is classified as external gamma radiation if an energy loss below the shield threshold is observed in section three but no energy loss is observed in the second section.

40. A method for detecting neutrons using the apparatus of claim 23, the first section comprising a neutron scintillator, the method comprising:
capturing a neutron in the first section;
measuring the light emitted from the first section as a consequence of the gamma radiation energy loss;
measuring the light emitted from the second section as a consequence of the gamma radiation energy loss;
determining the total energy loss of the gamma radiation, following a neutron capture, from the light emitted from the second section of the apparatus; and
classifying an event as neutron capture when the total energy loss measured in the second section is above 2,614 MeV when an energy loss has been detected in the first section at the same time and when no signal with an energy of above a certain shield threshold has been detected from the third section scintillator in the same time frame (anti-coincidence), said shield threshold being determined according to the following method:
measuring the thickness t (in cm) of the scintillator in the third section,
determining the energy Eₘᵢₙ (in MeV) corresponding to the energy deposition of minimum ionizing particles covering a distance t in said scintillator, by multiplying said thickness with the density of the scintillator material, given in g/cm³, and with the energy loss of minimum ionizing particles in said scintillator, given in MeV/(g/cm²), and
setting the shield threshold below said energy.

41. The method according to the claim 40, wherein the total energy loss of the gamma radiation, following a neutron capture is determined by adding the energy losses detected in the first and the second section.

42. The method according to claim 40, wherein the total energy loss of the gamma radiation, following a neutron capture is determined by adding the energy losses detected in the second and in the third section.

43. The method according to claim 40, wherein the total energy loss of the gamma radiation, following a neutron capture is determined by adding the energy losses detected in the first, second and in the third sections.

44. The method according to claim 40, where the measured total energy loss of the gamma radiation, following a neutron capture, is below a predetermined threshold.

45. The method according to claim 40, where an event is classified as external gamma radiation if an energy loss is detected in section two or in section three, but no energy loss above the shield threshold in section three and no energy loss in section one at the same time.

46. The apparatus of claim 1, wherein the inorganic material has an attenuation length of less than 5 cm for gamma rays of 5 MeV energy.

47. The apparatus of claim 1, wherein the evaluation device is configured to also classify detected radiation as neutrons when the measured total gamma energy is below 10 MeV.

48. The apparatus of claim 6, where the neutron scintillator is selected in a way that it has a sufficient gamma capture cross section to measure gamma energies of up to at least 500 keV with sufficient efficiency.

49. The apparatus of claim 11, where the different timing characteristics comprise different decay times for the emitted light.

50. The apparatus of claim 18, where the evaluation device is configured to classify detected radiation as neutrons when at least two gamma ray scintillators have detected a signal being due to gamma interaction, following a neutron capture in the first section.

51. The method according to claim 28, where an event is classified as neutron capture only when the total energy loss measured is below 10 MeV.

52. The method according to claim 32, where the total energy loss of the gamma radiation, following a neutron capture, is below a predetermined threshold.

53. The method according to claim 32, wherein the measured energy loss in the first section is below a predetermined threshold, said threshold being determined according to the following method:
measuring the thickness d (in cm) of the scintillator in the first section,
determining the energy Eₘᵢₙ (in MeV) corresponding to the energy deposition of minimum ionizing particles covering a distance d in said scintillator, by multiplying said thickness with the density of the scintillator material, given in g/cm³, and with the energy of minimum ionizing particles in said scintillator, given in MeV/(g/cm²), and
setting the threshold below said energy.

54. The method according to claim 33, wherein the measured energy loss in the first section is below a predetermined threshold, said threshold being determined according to the following method:
measuring the thickness d (in cm) of the scintillator in the first section,
determining the energy Eₘᵢₙ (in MeV) corresponding to the energy deposition of minimum ionizing particles covering a distance d in said scintillator, by multiplying said thickness with the density of the scintillator material, given in g/cm³, and with the energy loss of minimum ionizing particles in said scintillator, given in MeV/(g/cm²), and
setting the threshold below said energy.

55. The method according to claim 37, where an event is classified as neutron capture only when the total energy loss of the gamma radiation, following a neutron capture, is below a predetermined threshold.

56. The method according to claim 41, where the measured total energy loss of the gamma radiation, following a neutron capture, is below a predetermined threshold.

57. The method according to claim 42, where the measured total energy loss of the gamma radiation, following a neutron capture, is below a predetermined threshold.

58. The method according to claim 43, where the measured total energy loss of the gamma radiation, following a neutron capture, is below a predetermined threshold.
